(19) United States
(12) Patent Application Publication
(10) Pub. No.: US 2005/0183003 A1
(43) Pub. Date: Aug. 18, 2005

(54) Automatic proxy form filing

(75) Inventor: Doron Peri, Tel Aviv (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: CHECKPOINT SOFTWARE TECHNOLOGIES LTD.

(21) Appl. No.: 10/965,760

(22) Filed: Oct. 18, 2004

Related U.S. Application Data
(60) Provisional application No. 60/544,332, filed on Feb. 17, 2004.

(51) Int. Cl. G06F 17/00

(52) U.S. Cl. 715/507; 715/505; 709/203

(57) ABSTRACT

A method for automatically filling a form in a data network including an application server, a client and a user of the client. The method includes attaching a script to a page transmitted from the application server. The modified page is sent to the client and interpreted by a browser running on the client. The browser renders the modified page and then either: (i) records actions of the user during filling of the form, or (ii) fills the form by replaying the previously recorded actions.

### CROSS REFERENCE TO RELATED APPLICATION

This application claims the benefit from U.S. provisional application No. 60/544,332 filed on 17-Feb. 2004 by the same inventor.

### FIELD AND BACKGROUND OF THE INVENTION

The present invention relates to a system and method for automatically filling electronic forms in an information network, and more particularly for automatically filling out Web forms by simulating the interaction of a user with a Web form.

The World Wide Web is an information retrieval system that operates over the Internet. Information travels over the Internet, a worldwide client/server network. In the World Wide Web, the client is generally a software application, e.g. Web browser, installed on a personal computer. A user running a Web browser on a client sends a query for information to a Web server connected over the Internet.

Although information travels over the Internet primarily from the server to the client, often the client is required to provide information to the server. User information often includes personal information name, mailing address, telephone, business address, etc. For receiving user information, Web servers and Web browsers both support electronic forms. The use of electronic forms is time consuming on the part of the user as well as repetitive with many different electronic forms requiring the same information.

Often, confidential user information, for instance a credit card number or social security number is requested in a Web form. The use of confidential information in Web forms requires a high level of security for the user to feel comfortable sending the personal information over the Internet. In the context of enterprise security the system administrator needs to feel comfortable that confidential information is not exposed to theft.

Another example of confidential information in a Web form is a user name and password used to log in to an application on a remote server. A user signing on to a number of remote applications is required to remember the user name and password for each application. Therefore, it is not convenient for a user to be required to log in individually to a number of remote applications. Even for a single application used occasionally, the user often forgets the password and the user requires re-authorization by the application.

There is considerable prior art in the area of automatically filling Web forms.

A product called of Novell® Inc., Waltham, Mass., iChain® is an application that provides access to applications on behalf of authenticated users. iChain® requires prior configuration of specific Web applications typically by a system manager.

U.S. Pat. No. 6,192,380 entitled, “Automatic Web Based Form Fill-In”, is directed towards a method for automatically filling in web forms. The disclosed method includes code installed as part of a Web browser, or independent code installed on the client that interacts with the Web browser. Therefore, the method disclosed in U.S. Pat. No. 6,192,380 requires installation on the client of a modified Web browser or otherwise dedicated software installed on the client. Another disadvantage of the system disclosed in U.S. Pat. No. 6,192,380 is that confidential and otherwise sensitive information, e.g. credit card number is stored on the client computer, and therefore represents a security risk if the client computer is stolen.

U.S. Pat. No. 6,490,601 entitled, “Server for Enabling the Automatic Insertion of Data into Electronic Forms on a User Computer”, discloses another system and method for automatically filling on Web forms particularly for conducting purchase transactions over the Internet. The system of U.S. Pat. No. 6,490,601 uses a remote server or “privacy bank”. Individual merchants register with the privacy bank and supply the privacy bank with details of web forms. A user having an account with the “privacy bank” has an option to “click” on an icon of the privacy bank and the details required to fill the Web form are automatically downloaded with a “shippable code” and filled into fields of the electronic form by the client. The system and method of U.S. Pat. No. 6,490,601 has a number of disadvantages. One disadvantage is that personal, confidential and sensitive information is stored “off-site” in a remote server and sent over the Internet by a third party every time an electronic form document is filled. The method of U.S. Pat. No. 6,490,601 doesn't include “learning” the details of the form, and therefore the disclosure applies only to forms previously registered in the privacy bank. U.S. patent application 2002/0023108 discloses a subscription server that intercepts forms requested by Web servers, fills fields in the forms with data and submits the filled forms to the requesting Web servers on behalf of the client. The system of U.S. patent application 2002/0023108 also has the disadvantage of storing sensitive information “off-site” at the subscription server. The method disclosed in U.S. patent application 2002/0023108 requires that software running on the subscription server remotely monitors browsing activity on the part of the clients. In many environments, monitoring by the subscription server is not desired for security reasons, and represents a potential security risk and invasion of privacy for the clients. Web forms, e.g. log-in forms, may contain dynamic logic that is executed, i.e. with a script in the page, on the client during the loading of the Web page and filling of the form. For example, the server may send a certain dynamic value (e.g. time stamp) and expect to receive back the dynamic value in the data by a user. U.S. 2002/0023108 disregards the dynamic nature of forms or otherwise supports dynamic changes in forms by executing a program on the subscription server a method that carries a performance penalty. A form filling process based only on prior knowledge of the static structure of the Web form, such as the process disclosed in 2002/0023108 can lead to a false result. Once the user has submitted data, the same data will always be submitted again unchanged on behalf of the user even if the submitted data is no longer relevant or correct, e.g. one time password.

There is thus a need for, and it would be highly advantageous to have, a method for automatically filling electronic forms that overcomes the disadvantages of the prior art, particularly a flexible method that includes automatic learning the structure of electronic forms by recording the user actions when filling the form, a method that does not require a modified Web browser or additional software installed either on the client or on the Web server, a method that does not modify the content being displayed or dynamically produced by the Web server, a method that does not compromise the security and privacy of the clients and a method that supports dynamic changes in the forms.

### SUMMARY OF THE INVENTION

According to the present invention there is provided a method for automatically filling a form in a data network including an application server and a client and a user of the client. The data network further includes an intermediate server operatively connected between the client and the application server, the intermediate server mediates data traffic between the client and the application server; The method includes (a) receiving by the intermediate server a page sent from the application server for the client; (b) attaching a form-filling script by the intermediate server to the page thereby producing a form-filled page; wherein the form-filling script is interpretable by the client; and (c) sending the form-filled page to the client, wherein the form-filled page includes a reference to data, at least a portion of the data previously stored by recording previous actions of the user during filling of the form. Preferably, the form-filling script includes dynamic data. Preferably, the method further includes (d) executing the form-filled page by the client, thereby upon rendering the page, processing the form-filling script.

Preferably, prior to receiving a page from the application server, the intermediate server receives a request from a user of the client for an application from the application server and authenticates the user. Preferably, upon authenticating the user, the intermediate server authorizes the user for accessing the application, and verifies, that the data and the metadata are stored for the user and the application. Preferably, the form-filling script and the form-learning script are combined into a single script. Preferably, the client executes the form-filling script, and upon detecting the form, fills the form with the data for relaying to the application server, thereby producing a filled form. Preferably, the intermediate server intercepts the filled form for submitting to the application server.

Preferably, filling the form by the client includes filling placeholder values in fields requiring sensitive data and the intermediate server replaces the placeholder values with previously stored real values of sensitive data, wherein sensitive data are stored solely in storage operatively connected to the intermediate server, whereby the sensitive data is safely encrypted, protected by a security application or otherwise physically protected. Preferably, prior to attaching a form-filling script, the intermediate server attaches a form-learning script to the page thereby producing a form-learn page. The intermediate server sends the form-learning page to the client wherein the form-learning script is interpretable by the client. Preferably, the client executes the form-learning script and upon detecting by the client that the form-learning page includes the form, a user of the client fills the form with the data thereby producing a completed-form-learning page. The client analyzes the completed-form-learning page thereby producing said metadata. The client adds the data and the metadata to the completed-form learn page, thereby producing a metadata-filled page for sending to the application server. Alternatively, the client sends data and the metadata to the intermediate server and the intermediate server stores the data and the metadata. Preferably, the intermediate server intercepts the metadata-filled page and stores the data and the metadata whereby the data and the metadata are used to detect and to fill the form. Preferably, the intermediate server removes the metadata from the metadata-filled page, thereby producing a metadata-free page for relaying to the application server. Preferably, when the intermediate server receives the page from the application including an error, then the intermediate server attaches an error script to the page thereby producing an error page; the intermediate server sends the error page to the client and the client executes the error script by analyzing the error and executing either the form-learning script or the form-filling script.

According to the present invention, there is provided a system for automatically filling a form on behalf of user of a client in a data network, the data network further including an application server generating a page including the form, the system including (a) a processor; (b) a network interface configured as a server interface operatively connected between the processor and the application server and the network interface configured as a client interface operatively connected between the processor and the client; and (c) a storage mechanism operatively connected to the processor wherein the server interface receives a page sent from the application server to the client; and the processor attaches a form-filling script to the page thereby producing a form-filled page, the form-filling script being interpretable by the client and the processor sends the form-filled page to the client interface for the client, the form-filled page retrieving data previously stored by recording previous actions of the user during filling of the form, said data stored with the storage mechanism. Preferably, the server interface receives the page in response to a request by the client for an application from the application server. Preferably, the processor intercepts the form filled by the client with said data. Preferably, the client fills the form with placeholder values in fields requiring sensitive data and the processor replaces the placeholder values with real values of sensitive data previously stored with the storage mechanism. Sensitive data are stored solely with the storage mechanism. Preferably, the processor attaches a form-learning script to the page, and thereby produces a form-learning page and the processor sends the form-learn page to the client interface wherein the form-learning script is executable by the client and upon detection by the client that the form-learning page includes the form, a user of the client fills the form with data and thereby produces a completed-form-learning page. The client by running the form-learning script analyzes the completed-form-learning page thereby produces the metadata, the client adding the metadata to the completed-form learn page, thereby producing a metadata-filled page for sending to the application server. Preferably, the processor intercepts from the client interface the metadata-filled page and stores the data and the metadata with the storage mechanism. Preferably, the processor removes the metadata from the metadata-filled page, and thereby produces a metadata-free page for relaying to the server interface. Preferably, upon receiving an error indication from the application server, the processor attaches an error script to the page thereby produces an error page sent to the client; the client analyzes the error and executes a script either the form-learning script or the form-filling script.

According to the present invention there is provided a method for recording actions of a user of a client during filling a form in a web page, in a data network including the client, and an application server, the method including: (a) receiving a page sent from the application server for the client; and (b) attaching a form-learning script to the page, thereby producing a form-learning page. Preferably, the method, further includes: (c) executing the form-learning page by a browser on the client, thereby upon rendering the page processing the form-learning script, thereby performing the recording of the actions of the user.

According to the present invention, there is provided a method for automatically filling a form in a data network including an application server, a client and a user of the client, the method including: (a) attaching a form-filling script to a page transmitted from the application server, thereby producing a form-filled page; wherein said form-filling script is interpretable by a browser running on the client; (b) sending the form-filled page to the client; and (c) executing the form-filled page by the browser, thereby upon rendering the page, retrieving data for the filling the form, wherein the data is previously stored by recording actions of the user during filling of the form. Preferably, the filling the form is performed by playing the recording.

According to the present invention there is provided a program storage device readable by a machine tangibly embodying a program of instructions executable by the machine to perform the methods as described herein.

### BRIEF DESCRIPTION OF THE DRAWINGS

The invention is herein described, by way of example only, with reference to the accompanying drawings, wherein:

FIG. 1 is a simplified schematic drawing of a system for automatically filling forms, according to an embodiment of the present invention;

FIG. 2 is a simplified drawing of a system for automatically filling forms, the system installed in a network according to an embodiment of the present invention;

FIG. 2a is a simplified drawing of an intermediate server, part of a system for automatically filling forms, according to an embodiment of the present invention;

FIG. 3 is a flow chart of a method for learning the structure of new forms, according to an embodiment of the present invention;

FIG. 4 is a flow chart of a method for automatically filling forms, according to an embodiment of the present invention;

FIG. 5 is a flow chart of a method for managing errors and re-authentication, according to an embodiment of the present invention; and

FIG. 6 is a flow chart of intermediate server logic, according to an embodiment of the present invention.

### DESCRIPTION OF THE PREFERRED EMBODIMENTS

The present invention is of a system and method for automatically filling electronic forms in an information network. Specifically, the present invention can be used to automatically learn the structure of electronic forms, and to record the actions of the user filling the form. After the user has filled a form, the system stores data pertinent to the user and fills subsequent electronic forms similar to the form already filled by the user by replaying the recorded user actions. The system and method of the present invention requires a standard browser only, and does not require any additional software to be installed on the client. The system and method of the present invention does not store sensitive data on the client and preferably avoids sending sensitive data over the Internet and does not require monitoring client activity by a server. The method of the present invention further supports dynamic changes in the form. The invention does not require any modification to the application server or the content stored on it.

According to an embodiment of the present invention, a form-learning script is inserted into a web page requested by the user, creating a form-learning page sent to the client. After the page is rendered, the form-learning script executes. If there is a form in the page, the execution of the script records the actions of the user. Certain elements of the data submitted are dynamic, i.e. may change at the time of data submission (e.g. verification of time stamps), and these changes are accurately recorded.

The principles and operation of a system and method for automatically filling electronic forms in an information network according to the present invention may be better understood with reference to the drawings and the accompanying description.

Before explaining embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The present invention includes the use of an intermediate server. The intermediate server, in different embodiments of the present invention may be implemented in different ways including a separate reverse proxy server, or a plug-in filter in a Web server, or an intermediate server located in a wide area network. Preferably, the intermediate server, according to the present invention is a reverse proxy server, or a plug-in to a local Web server a configuration that is readily secured such as by a local firewall and/or intrusion detection system, as opposed to a configuration that the intermediate server is located in a wide area network, e.g. Internet.

The present invention includes the use of a script, typically JavaScript interpretable and executable by a standard Web browser. The term “script” is defined herein to include any programming language interpretable and executable by an application running on a client. The term “page” although typically referring to an HTML page interpreted and presented by a Web browser on a client, is defined herein to include information sent from a server to a client in any form, language or protocol.

The term “client” is defined herein to include a computer, cellular telephone or other computerized device being operating by a user and running an application such as a Web browser that interprets a script. The term “user” of a client is defined herein to include another person, e.g. administrator, acting on behalf of the user. The term “sensitive data” includes passwords, credit card numbers, social security numbers that a user prefers not to risk disclosing accidentally. The term “metadata” as defined herein includes information describing the structure and interpretation of electronic forms. The term “data” is used herein to include user submitted data, e.g. username, password and metadata. The terms “application”, “application server” and “web site” are used herein interchangeably. The terms “data” and “information” are used herein interchangeably.

In the context of the present invention, a number of mechanisms may be used to store and retrieve information. These mechanisms include storing information in a Web page, or including a reference in the Web page to information stored in memory, e.g. by an intermediate server. The terms “including a reference” to information, or “including information” are equivalent and refer to any information storage mechanism.

By way of introduction, the principal intention of the present invention is to provide a system and method for automatically filling electronic forms in an information network overcoming the disadvantages of prior art systems. Specifically the present invention provides automatic filling of forms wherein a method is provided for learning the structure of forms and for using stored data input once only by the user; (1) the electronic forms to be filled do not require a prior manual configuration for web site content and/or web form structure; (2) client software installation is not required other than a standard Web browser; (3) no modifications are required to application Web servers (4) sensitive data, e.g. passwords, are securely stored and, sensitive data travel over secure network paths, e.g. not over the Internet; (5) a replay of the users recorded actions provides static and dynamic form filling without any prior assumptions regarding the nature of the form being filled.

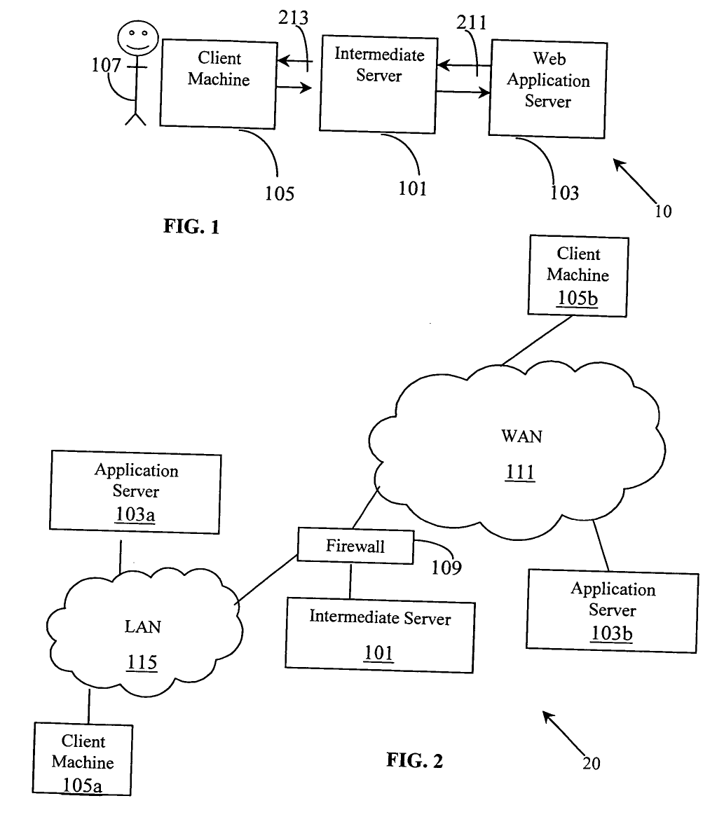

Referring now to the drawings, FIG. 1 illustrates a simplified form-filling system 10 for automatically filling forms. System 10 includes a user 107 using a standard Web browser on a client 105, e.g. a personal computer, or cellular telephone. Client 105 typically sends a request, e.g. for login, over the Internet to an application server 103. System 10 includes an intermediate server 101 configured to mediate communications between client 105 and application server 103. Intermediate server 101 is configured to include a client interface 213 for communicating with client 105 and a server interface 211 for communicating with application server 103. Client interface 213 and server interface 211 are typically implemented in software over a single network interface (not shown). Alternatively, two hardware interfaces are used for both client interface 213 and server interface 211, for instance when the implementation is part of firewall 109.

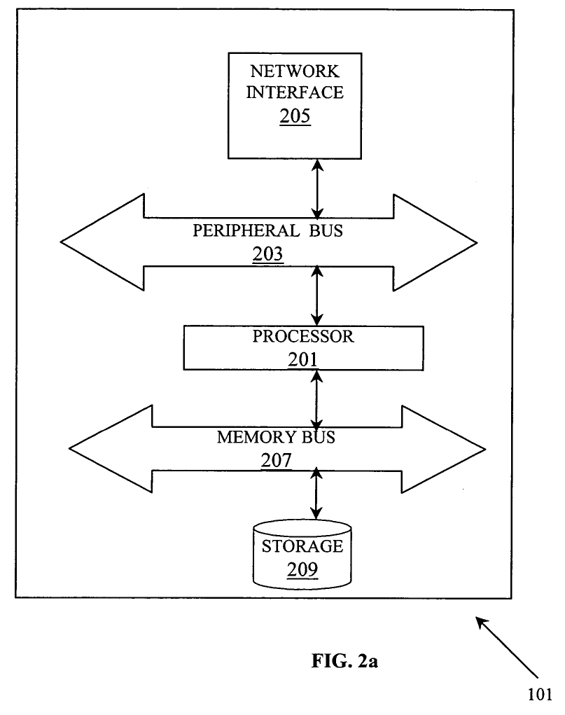

FIG. 2 illustrates integration of form filling system 10 in an information network 20, according to an embodiment of the present invention. Information network 20 includes a wide area network (WAN) 111, e.g. Internet and a local area network (LAN) 115. Client 105a and application server 103a are both connected to LAN 115. Client 105b and application server 103b are both connected to WAN 111. Information network 20 further includes a firewall 109 configured to protect LAN 115 from intrusions from WAN 111. Intermediate server is connected to firewall 109.

FIG. 2a is an illustration showing some of the components of intermediate server 101, according to an embodiment of the present invention. Intermediate server 101 includes a processor 201, a storage mechanism including a memory bus 207 to store information in memory 209 and a network interface 205 preferably configured as both client interface 213 and server interface 211, network interface 205 operatively connected to processor 201 with a peripheral bus 203.

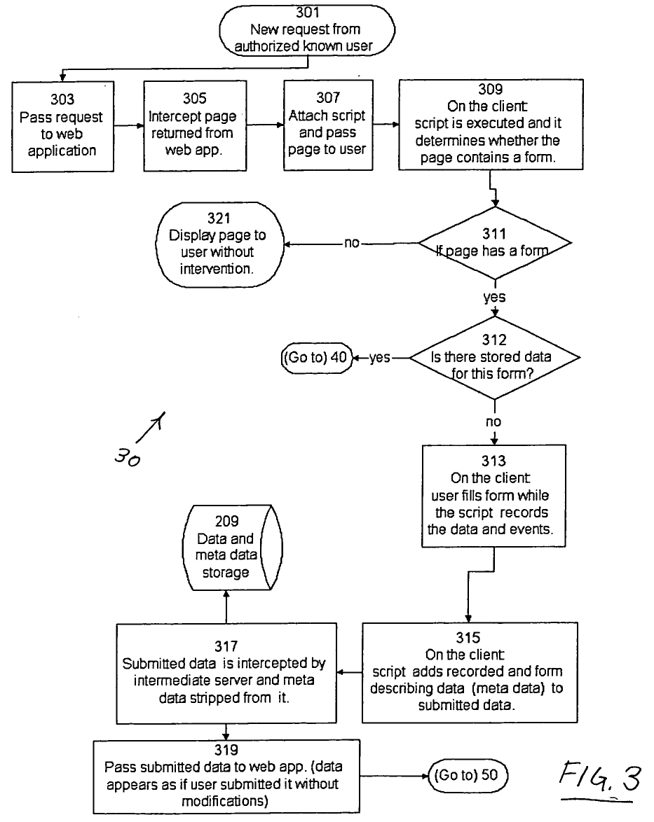

The operation of system 10 in information network 20, according to an embodiment of the present invention, is best understood with reference to flow charts of FIGS. 3-5. FIG. 3 illustrates a learning process 30 for learning to fill electronic forms. Learning process 30 begins with a new request received (step 301) by intermediate server 101. The new request is for instance a request by user 107 to log in to an application on application server 103. The request is passed (step 303) to application server 103. Application server 103 responds by sending (not shown) a page that is intercepted (step 305) by intermediate server 101. Intermediate server 101 attaches (step 307) a script to the page, producing a modified page and intermediate server 101 sends the modified page to client 105.

If the page intercepted (step 305) by intermediate server 101 from application server 103 is compressed, intermediate server 101 is required to decompress the page; or preferably, intermediate server 101 can disable compression for instance by deleting HTTP Accept-Encoding header coming from the Web browser on client 105. At client 105, a standard Web browser analyzes and executes (step 309) the modified page containing the script. Intermediate server 101 arranges the modified page in such a way that the execution of the script by the browser is performed after the browser running on client 105 has completed rendering the original Web page that came from the application server and has executed all other scripts that application server 103 may have placed in the original Web page. At client 105, execution (step 309) of the script includes detection if the page includes a form, e.g. log-in, that user 107 wants to be filled automatically. If the page includes a form (decision block 311), and there is no data stored already to automatically fill the form (decision block 312), then user 107 fills the form with the required data, e.g. user name and password, and submits (step 313) the completed-form-learning page intended for application server 103. Otherwise, if the form is not detected (decision block 311), client 105 displays (step 321) the response “as-is” to the user 107. If the form is detected (decision block 311), the Web browser further executes the script, now a form learning script, and analyzes the completed form-learning page adding (step 315) metadata to the submitted completed-form-learning page to produce a metadata-filled page. Adding metadata is intended not to interfere with the normal function of applications running on application server 103. Intermediate server 101 intercepts (step 317) the metadata filled page and stores data and metadata in storage 209. The metadata is removed (step 317) from the metadata-filled page and passed through server interface 211 to application server 103. In another possible implementation the metadata is sent by client 105 to application server 103 separately from the form submitted (step 313) by the client even to a different server other than intermediate server 101. In this case removing (step 317) the metadata is not relevant.

The modified page, in process 30 a form learning page including the learning script, performs two functions at step 313: (1) static analysis of page structure and (2) dynamic analysis that is performed while the user actually fills the form (step 313), e.g. logs-in. An HTML page is typically represented in memory of a browser in a tree-like data structure called DOM (Document Object model). The static HTML structure may look like the following:

<html>
<body>
<form id=“myForm”>
<input type=“text” id=“myInput1”>
<input type=“password” id=“myInput2”>
<input type=“submit” id=“mySubmit”>
</form>
</body>
</html>

The DOM is created immediately when the page finishes loading. The static analysis, using an application interface e.g. DOM API enables scripts running in the page to access different elements of data in the page such as forms and input fields.

The dynamic analysis is intended to cope with changes, if any occur in the form, during filling (step 313) the form by the user. A Web page may incorporate scripts that respond to user driven events or perform runtime calculations. Such scripts may for instance copy the content of one input field into a different input field. Another dynamic input field is a time stamp that is calculated, for instance, based on the system clock. According to an embodiment of the present invention, the actions of the user are recorded exactly when the actions occur including any dynamic filling of input fields.

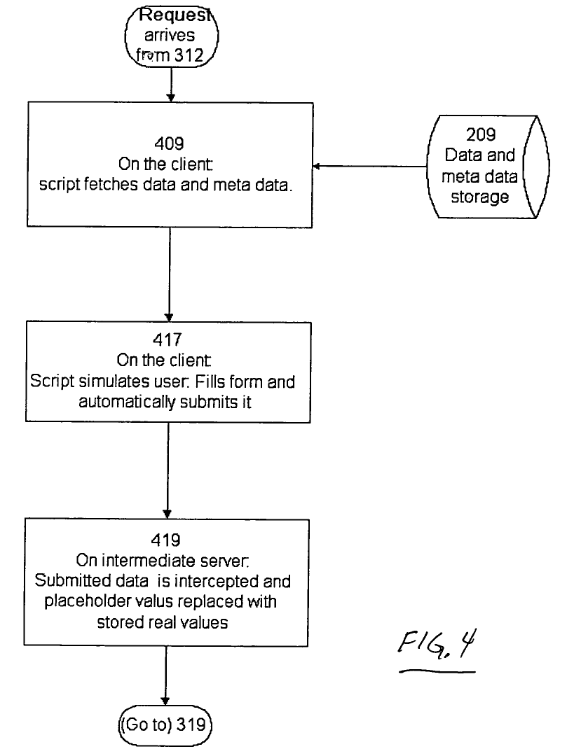

FIG. 4 illustrates a process 40 for filling a form subsequent to completion of learning process 30 and successful storage of user submitted data and metadata for the form. The accurate recording (process 30) of the filling of dynamic data and the automatic filling (process 40) on the client simulating the user insure that the form input data is always correct and up to date. Referring now to FIG. 4, user 107 requests (step 301), for instance to log in to an application on application server 103. User 107 has previously initiated learning process 30; data, e.g. user name and password regarding the log-in is stored in metadata storage 209. User request goes through process 30 again and this time the decision in block 312 is positive. The modified script is now a form filling script. Relevant data for filling the form is fetched (step 409). In this embodiment, the modified script functions as both a learning script in process 30 and a filling script in process 40. Alternatively, different scripts, i.e. a learning script for process 30 and a filling script for process 40 may be used.

The form filling script may include data, e.g. user name and password, and metadata previously stored in storage 209 during learning process 30. Alternatively, the form filling script imports the data dynamically, e.g. in form of an XML query, thus eliminating the possibility that the Web browser will cache a page similar to the form-filled page. The form filling script fills and submits (step 417) the form using the user submitted data and metadata included in the form-filled page The execution of the form filling script is performed after the browser has rendered the original page, but not necessarily displayed to the user, and after any scripts sent by application server 103 are executed.

According to an embodiment of the present invention, if the submitted form-filled page includes sensitive data, e.g. password, then submission (step 417) includes only placeholder values, e.g. “*****” in the place of the sensitive data. Submission (step 417) is intercepted (step 419) by intermediate server 101 that replaces the placeholder values with a password, e.g. 5f6Ud, the password previously stored as data in storage 209. The form-filled page is then passed (step 319) by intermediate server 101 to application server 103 preferably via server interface 211. Server interface 211 is preferably connected to a network, e.g. LAN 115 which is safer than the network, e.g. WAN 111 connected to client interface 213. Preferably, sensitive data is safely stored in storage 209 encrypted, protected by a security application and otherwise physically protected.

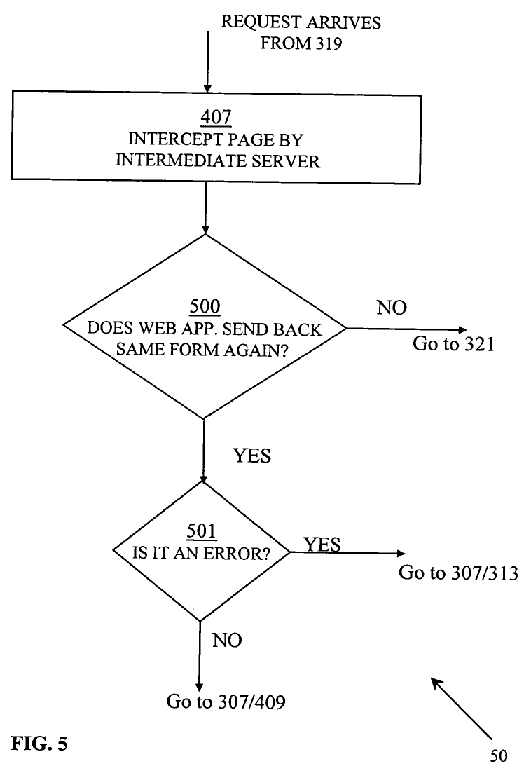

Referring back to step 319, if an error condition exists during learing process 30 or form filling process 40, i.e. data submitted is not accepted, or the web application is requiring re-authentication from client 105, then error/re-authentication process 50 is performed, as illustrated in FIG. 5. Error/re-authentication process 50 includes decision block 500 that decides whether the same form is encountered again, and decision block 501 that decides whether an error, e.g. incorrect password, occurred, or a periodic request occurred to re-authenticate user 105. One mechanism to distinguish between these two conditions uses the passage of time. For instance, if a password is rejected then intermediate server intercepts (step 407) a page including a log-in form immediately, e.g within 3 minutes, after a modified script was attached (step 307) including the same form. In this case, an error condition is expected and the flow from step 307 proceeding to step 313 and on (in process 30) is repeated to enable user to enter correct data and submit again. Otherwise, the log-in request is assumed to be a periodic request by application server 103 for re-authentication and the flow from 307 and from 409 (in process 40) is repeated to fill form automatically Preferably, caching of certain Web pages or scripts by the Web browser on client 105 is disabled or otherwise prevented to insure proper operation of the present invention. Since the browser might cache Web pages and scripts, one embodiment of the present invention prevents caching so that the form-filling process does not recur for instance because the form-filling script (script 2) is retrieved from the cache and executed instead of the error script (script 3) when an error/re-authentication process is expected.

Similarly, auto-completion of forms by the Web browser is disabled so that the Web browser does not store sensitive data on client 105.

Preferably, intermediate server 101 detects when user 107 logs off from the Web application. Preferably, log off detection occurs if the Web application directs the user back to a login page. A login page is detected by for instance analyzing all the fields in a form in a page of type “password”. Alternatively, an URL of the login page may be known in advance.

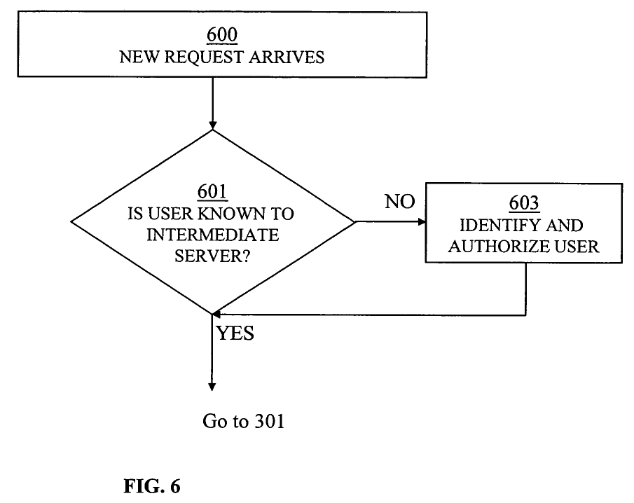

FIG. 6 illustrates processing of requests by intermediate server 101, according to an embodiment of the present invention. A new request arrives (step 600) to intermediate server 101 from user 107. If user 107 is not yet authorized, an authorization process (step 603) occurs. Typically, a password is required for authorization of user 107. The process of FIG. 6 is a single authorization process, i.e. single sign-on, performed by intermediate server 101 avoiding the requirement to perform multiple authorization processes for each application. Once user 107 is authorized, further authorization is not required, once the login data is stored. Intermediate server 101 identifies if the requested application is supported and if so, initiates process 30 (step 301). In some embodiments of the present invention, the system operates in a mode where no application at all is pre-configured and that any form with a previously defined set of characteristics encountered by the system is analyzed, learned and automatically filled thereafter.

When messages to the user, e.g. notification or request for approval of the process are used, the scripts preferably add an HTML “DIV” block which display the message. The use of this type of block guarantees that the new message is displayed over the original structure without modifing in any other way the original structure of the page. The use of this method avoids detection by “pop-up killers”.

Referring back to FIG. 2 illustrating a form filling system 10 installed in information network 20, according to an embodiment of the present invention. Intermediate server 101 is installed in the demilitarized zone of firewall 109 protecting LAN 115. Client 105b is run by user 107, e.g. a corporate employee working off site. User 107 requests an application installed on application server 103a installed within LAN 115. Intermediate server 101 authorizes user 107 and client 105b. Intermediate server 101, having previously stored login information regarding user 107, provides the appropriate login to the application. Preferably, user 107 is not necessarily aware that intermediate server 101 is performing a login on his/her behalf. Alternatively, specific input fields can be made visible to user 107 by the form-filling script by controlling the height and width dimension of the field, i.e. a zero dimension renders the input field invisible.

User 107 is not required to remember the login information. Furthermore, the password is not sent over WAN 111, but only placeholder values; the sensitive data, e.g. password is more securely maintained within the corporate portal and LAN 115. If client 105 is stolen, security risk is minimized because sensitive data, e.g. multiple application passwords are not stored on client 105.

With respect to the above description then, it is to be realized that the optimum function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

1. A method for automatically filling a form in a data network including an application server a client and a user of the client, the data network further including an intermediate server operatively connected between the client and the application server, the intermediate server mediating data traffic between the client and the application server, the method comprising the steps of:
(a) receiving by the intermediate server a page sent from the application server for the client;
(b) attaching a form-filling script by the intermediate server to said page thereby producing a form-filled page; wherein said form-filling script is interpretable by the client; and
(c) sending said form-filled page to the client,
wherein said form-filled page includes a reference to data, at least a portion of said data previously stored by recording at least one previous action of the user during filling of the form.

2. The method, according to claim 1, wherein at least a portion of the form is dynamic.

3. The method, according to claim 1, further comprising the step of:
(d) executing said form-filled page by the client, thereby upon rendering said page, processing said form-filling script.

4. The method, according to claim 1, further comprising the step of, prior to said receiving:
(d) receiving by the intermediate server a request from the user for an application from the application server; and
(e) authenticating the user.

5. The method, according to claim 4, further comprising the step of, prior to said attaching:
(f) upon authenticating the user, authorizing the user for accessing said application, and verifying if said previously stored data are stored for the user and said application.

6. The method, according to claim 1, further comprising the step of:
(d) executing by the client said form-filling script, thereby upon detecting the form, filling the form with said data for relaying to the application server, thereby producing a filled form for submitting to the application server.

7. The method, according to claim 6, the method further comprising the step of:
(e) intercepting the filled form by the intermediate server.

8. The method, according to claim 7, wherein said filling the form by the client includes filling placeholder values in fields requiring sensitive data, the method further including the step of:
(f) replacing by the intermediate server of said placeholder values with previously stored real values of sensitive data;
wherein sensitive data are stored solely in storage operatively connected to the intermediate server;
whereby said sensitive data is safely encrypted, protected by a security application or otherwise physically protected.

9. The method, according to claim 1, further comprising the steps of, prior to said (b) attaching:
(d) attaching by the intermediate server a form-learning script to said page thereby producing a form-learning page;
(e) sending by the intermediate server said form-learning page to the client; wherein said form-learning script is interpretable by the client.

10. The method, according to claim 9, wherein said form-filling script and said form-learning script are combined into a single script.

11. The method, according to claim 9, further comprising the steps of:
(f) executing by the client said form-learning script, thereby upon detecting by the client that said form-learning page includes the form, filling the form by the user of the client with said data thereby producing a completed-form-learning page and analyzing by the client said completed-form-learning page thereby producing metadata.

12. The method, according to claim 11, further comprising the step of:
(g) adding by the form-learning script running in the client said data and said metadata to said completed-form learn page, thereby producing a metadata-filled page for sending to the application server;

13. The method, according to claim 11, further comprising the steps of:
(g) sending by the client said data and said metadata to the intermediate server;
(h) storing by the intermediate server said data and said metadata in storage;
whereby said metadata are used for said detecting and said filling the form by the intermediate server.

14. The method, according to claim 12, further comprising the steps of:
(h) intercepting by the intermediate server said metadata-filled page;
(i) storing by the intermediate server said data and said metadata in storage;
whereby said data and metadata are used for said detecting and said filling the form by the intermediate server; and
(j) removing by the intermediate server of said metadata from said metadata-filled page, thereby producing a metadata-free page for relaying to the application server.

15. The method, according to claim 1, wherein said (a) receiving includes an error, the method further comprising the steps of:
(k) attaching by the intermediate server an error script to said page thereby producing an error page;
(l) sending by the intermediate server said error page to the client; and
(m) executing said error script, thereby analyzing the error and executing a script selected from the group of said form-learning script and said form-filling script.

16. A system for automatically filling a form on behalf of a user of a client in a data network, the data network further including an application server generating a page including the form, the system comprising:
(a) a processor;
(b) at least one network interface configured as a server interface operatively connected between said processor and the application server, said at least one network interface further configured as a client interface operatively connected between said processor and the client; and
(c) a storage mechanism operatively connected to said processor
wherein said server interface receives the page sent from the application server to the client;
wherein said processor attaches a form-filling script to said page thereby producing a form-filled page, said form-filling script being interpretable by the client and said processor sends said form-filled page to the client interface for the client, said form-filled page retrieving data, at least a portion of said data previously stored by recording at least one previous action of the user during filling of the forms said data stored with said storage mechanism.

17. The system, according to claim 16, wherein said server interface receives said page in response to a request by the client for an application from the application server.

18. The system, according to claim 16, wherein said processor intercepts the form filled by the client with said data.

19. The system, according to claim 18, wherein the form is filled by the client in fields requiring sensitive data with placeholder values and said processor replaces said placeholder values with real values of sensitive data previously stored with said storage mechanism, wherein sensitive data are stored solely with said storage mechanism.

20. The system, according to claim 18, wherein said processor attaches a form-learning script to said page, and thereby produces a form-learning page and said processor sends said form-learning page to the client interface;
wherein said form-learning script is executable by the client and upon detection by the client that said form-learning page includes the form, said user fills the form with data and thereby produces a completed-form-learning page, wherein by running the form-learning script the client analyzes said completed-form-learning page and thereby produces metadata, the client adding said data and said metadata to said completed-form learn page, thereby producing a metadata-filled page for sending to the application server.

21. The system, according to claim 20 wherein said processor intercepts from the client interface said metadata-filled page and stores said data and said metadata with said storage mechanism.

22. The system, according to claim 21 wherein said processor removes said metadata from said metadata-filled page, and thereby produces a metadata-free page for relaying to said server interface.

23. The system, according to claim 16, wherein said processor upon receiving an error indication from the application server, said processor attaching an error script to said page thereby producing an error page sent to the client, the client analyzing the error and thereby executing a script selected from the group of said form-learning script and said form-filling script.

24. A method for recording at least one action of a user of a client during filling a form in a web page, in a data network including the client, and an application server, the method comprising the steps of:
(a) receiving a page sent from the application server for the client; and
(b) attaching a form-learning script to said page, thereby producing a form-learning page.

25. The method, according to claim 24, further comprising the step of:
(c) executing said form-learning page by a browser on the client, thereby upon rendering said page processing said form-learning script, thereby performing the recording.

26. A method for automatically filling a form in a data network including an application server, a client and a user of the client, the method comprising the steps of:
(a) attaching a form-filling script to a page transmitted from the application server, thereby producing a form-filled page; wherein said form-filling script is interpretable by a browser running on the client;
(b) sending said form-filled page to the client; and
(c) executing said form-filled page by said browser, thereby upon rendering the page, retrieving data for the filling the form, wherein at least a portion of said data is previously stored by recording at least one previous action of the user during filling of the form.

27. The method, according to claim 26, wherein the filling the form is performed by playing said recording.

28. A program storage device readable by a machine tangibly embodying a program of instructions executable by the machine to perform a method for automatically filling a form in a data network including an application server, a client and a user of the client, the method comprising the steps of:
(a) attaching a form-filling script to a page transmitted from the application server, thereby producing a form-filled page; wherein said form-filling script is interpretable by a browser running on the client;
(b) sending said form-filled page to the client; and
(c) executing said form-filled page by said browser, thereby upon rendering the page, retrieving data for the filling the form, wherein at least a portion of said data is previously stored by recording at least one previous action of the user during filling of the form.

29. A program storage device readable by a machine tangibly embodying a program of instructions executable by the machine to perform a method for recording at least one action of a user of a client during filling a form in a web page, in a data network including the client, and an application server, the method comprising the steps of:
(a) receiving a page sent from the application server for the client; and
(b) attaching a form-learning script to said page, thereby producing a form-learning page.

30. A program storage device readable by an intermediate server tangibly embodying a program of instructions executable by the intermediate server to perform a method for automatically filling a form in a data network including an application server a client and a user of the client, the data network further including the intermediate server operatively connected between the client and the application server, the intermediate server mediating data traffic between the client and the application server, the method comprising the steps of:
(a) receiving by the intermediate server a page sent from the application server for the client;
(b) attaching a form-filling script by the intermediate server to said page thereby producing a form-filled page; wherein said form-filling script is interpretable by the client; and
(c) sending said form-filled page to the client,
wherein said form-filled page includes a reference to data, at least a portion of said data previously stored by recording at least one previous action of the user during filling of the form.
